(19) United States
(12) Patent Application Publication
(10) Pub. No.: US 2026/0024714 A1
(43) Pub. Date: Jan. 22, 2026

(54) CIRCUIT PROTECTION APPARATUS

(71) Applicant: CITEL, PARIS (FR)

(72) Inventors: Xiaozhen LI, Shanghai (CN); Jianzhe YE, Shanghai (CN); Hui WANG, Shanghai (CN); Xueping DENG, Shanghai (CN); Zewei ZHU, Shanghai (CN)

(21) Appl. No.: 19/266,761

(22) Filed: Jul. 11, 2025

(30) Foreign Application Priority Data
Jul. 16, 2024 (CN) 202410952388.9

(51) Int. Cl. H01H 71/02; H01H 71/52; H01H 85/02

(52) U.S. Cl. CPC H01H 71/02; H01H 71/521; H01H 85/0241

(57) ABSTRACT

A circuit protection apparatus has a first housing, a handle assembly installed in the first housing, and a tripping mechanism installed in the first housing. The handle assembly is connected to the tripping mechanism. The tripping mechanism has a first output end, an electromagnetic mechanism installed in the first housing. The electromagnetic mechanism has a movable second output end that is used for contacting with the tripping mechanism. The first housing is detachably mounted on the second housing. A moving contact assembly is installed in the second housing and the first output end is connected to the moving contact assembly for forming a main electrical connection when the first output end is in the first position and for breaking the main electrical connection when the first output end is in the second position.

### CROSS-REFERENCE TO RELATED APPLICATIONS

This application claims priority to Chinese Patent Application No. CN202410952388.9 filed Jul. 16, 2024, the content of which is incorporated herein by reference in its entirety.

### BACKGROUND OF THE INVENTION

### Field of the Invention

The present invention relates to the technical field of circuit protection, in particular to a circuit protection apparatus.

### Description of the Related Art

At present, surge protective device (SPD) are widely used in low-voltage distribution systems in various scenarios to provide safety protection for various electronic equipment, to avoid surges caused by external interference, that is, instantaneous overvoltages that exceed normal conditions cause damage to equipment. In the case of accidents, the damage of the SPD is easy to cause electrical fire and other risks, which are easy to bring large economic losses.

In the prior art, the traditional circuit breaker or fuse is generally considered to realize the backup protection of the SPD. However, the existing SPD backup protection scheme is relatively limited in the range of current threshold that can be triggered, and there is still a blind spot of the current threshold so that the protection of SPD cannot be realized normally, and there is still the risk of fire. In addition, the existing SPD protection device is limited by the installation space, the protection function is single, the installation and disassembly are relatively inconvenient, and it is difficult to apply the circuit layout of different specifications.

### SUMMARY OF THE INVENTION

In order to solve the above technical issues, the object of the invention provides a circuit protection apparatus, comprising:
a first housing;
a handle assembly, installed in the first housing;
a tripping mechanism, installed in the first housing, the handle assembly is connected to the tripping mechanism, and the tripping mechanism has a first output end, the first output end is movable in a first position or a second position;
an electromagnetic mechanism, installed in the first housing, the electromagnetic mechanism has a movable second output end, and the second output end is used for contacting the tripping mechanism;
wherein,
the handle assembly is used for controlling the tripping mechanism to be in a locking state or a tripping state;
when the tripping mechanism is in the locking state, the first output end is in the first position;
when the tripping mechanism is in the tripping state, the first output end is in the second position which is different from the first position;
the electromagnetic mechanism is used for driving the tripping mechanism to enter the tripping state from the locking state;
further comprising:
a second housing, the first housing is detachably mounted on the second housing;
a moving contact assembly, installed in the second housing, the first output end is connected to the moving contact assembly;
a static contact assembly, installed in the second housing, the moving contact assembly and the static contact assembly are used for forming a main electrical connection when the first output end is in the first position and for breaking the main electrical connection when the first output end is in the second position.

In another preferred embodiment, the first housing comprises a first portion and a second portion sequentially arranged along a horizontal direction;
the handle assembly is arranged at the upper part in the first portion, and the electromagnetic mechanism is arranged at the lower part in the first portion;
the tripping mechanism is arranged in the second portion.

In another preferred embodiment, an opening is formed on the first housing, the first output end passes through the opening and extends outward of the first housing.

In another preferred embodiment, the handle assembly comprises: an operating portion, a rotating portion and a connecting rod;
the rotating portion is movably installed in the first housing, one end of the operating portion is connected to the rotating portion, and an other end of the operating portion passes through the first housing and extends outwardly;
one end of the connecting rod is linked with the rotating portion, and an other end of the connecting rod is connected to the tripping mechanism.

In another preferred embodiment, the tripping mechanism comprises:
a rotating disc, rotatably arranged in the first housing;
a first connector, two ends of the first connector are connected to the rotating disc and the handle assembly respectively;
a second connector, one end of the second connector is connected to the rotating disc, an other end of the second connector forms a contact end, and the contact end is used for contacting the second output end;
a third connector, one end of the third connector is connected to the rotating disc, and an other end of the third connector forms the first output end;
wherein, the first connector matches the second connector so that the tripping mechanism is in the locking state or the tripping state.

In another preferred embodiment, a protrusion is formed on the first connector, and a depression is formed on the second connector;
when in the locking state, the protrusion extends into the inner of the depression;
when in the tripping state, the protrusion detaches outwards from the inner of the depression.

In another preferred embodiment, the circuit protection apparatus further comprising: a first elastic element, wherein the first elastic element is arranged between the first housing and the rotating disc.

In another preferred embodiment, the circuit protection apparatus further comprising: a second elastic element, the second elastic element is arranged below the tripping mechanism, and the second elastic element is used for contacting the contact end of the second connector.

In another preferred embodiment, the circuit protection apparatus further comprising: a third elastic element, the third elastic element is arranged between the first housing and the rotating portion.

In another preferred embodiment, the circuit protection apparatus further comprising: a fourth connector, a first moving contact and a first static contact, the fourth connector is connected to the handle assembly, the first moving contact is arranged on the fourth connector, the first static contact is arranged below the fourth connector, and the first moving contact movably contacts the first static contact.

In another preferred embodiment, wherein the moving contact assembly has at least one second moving contact, the static contact assembly has at least one second static contact, the first output end is used for driving at least one the second moving contact to contact or separate from at least one the second static contact.

In another preferred embodiment, the moving contact assembly comprises: a rotating support and at least one fourth elastic element;
the rotating support is rotatably arranged in the second housing, and the rotating support is connected to the first output end;
the rotating support is provided with a guide channel, one end of the second moving contact is movably installed in the guide channel, and the fourth elastic element is arranged between one end of the second moving contact and the inner wall of the guide channel;

An other end of the second moving contact extends to the outer side of the rotating support and is used for contacting the second static contact.

In another preferred embodiment, a limiting block is formed on the second moving contact, a limiting groove is formed in the guide channel, and the limiting block is slidably arranged in the limiting groove.

In another preferred embodiment, the circuit protection apparatus further comprising: a fuse, the fuse is configured to disconnect the main electrical connection.

In another preferred embodiment, the fuse is at least electrically connected to the moving contact assembly.

In another preferred embodiment, the lower part of the second housing forms an enclosed space, the fuse is arranged in the enclosed space, and the enclosed space is filled with filler.

The present invention adopts the above-mentioned technical scheme, compared with the prior art, it has a positive effect as follows:

Through the application of the present invention, a switch module with a relatively compact structure is provided, the corresponding circuit is turned on or off by manually operating handle assembly and the automatically triggering the electromagnetic mechanism, its working stability is strong, and it is convenient for installation and disassembly; after being easily matched to the corresponding circuit protection apparatus, it can be further combined with the fuse function, to eliminate the problem that the blind spot of the current threshold cannot trigger the protection as much as possible, realizes the better protection effect, and further improves the safety.

### BRIEF DESCRIPTION OF THE DRAWINGS

FIG. 1 is an overall schematic diagram of a circuit protection apparatus in an embodiment of the present invention;

FIG. 2 is an exploded view of the circuit protection apparatus of FIG. 1, showing a compact switch module and a base;

FIG. 3 is a section view of the circuit protection apparatus of FIG. 1;

FIG. 4 is a first partial schematic diagram of the circuit protection apparatus of FIG. 1;

FIG. 5 is a second partial schematic diagram of the circuit protection apparatus of FIG. 1;

FIG. 6 is an internal schematic diagram of the circuit protection apparatus of FIG. 1.

In the Figs:
100. Compact switch module; 110. First housing; 120. Handle assembly; 130. Tripping mechanism; 131. First output end; 140. Electromagnetic mechanism; 141. Second output end; 111. First portion; 112. Second portion; 121. Operating portion; 122. Rotating portion; 123. Connecting rod; 132. Rotating disc; 133. First connector; 134. Second connector; 135. Contact end; 136. Third connector; 137. Protrusion; 138. Depression; 101. First elastic element; 102. Second elastic element; 103. Third elastic element; 104. Transmission shaft; 105. Fourth connector; 106. First moving contact; 107. First static contact; 300. Circuit protection apparatus; 200. Base; 201. Second moving contact; 202. Second static contact; 210. Second housing; 203. Slot structure; 220. Moving contact assembly; 230. Static contact assembly; 221. Rotating support; 222. Fourth elastic element; 223. Guide channel; 224. Limiting block; 225. Limiting groove; 240. Fuse; 241. Enclosed space; 204. Screw; 205. First terminal; 206. Second terminal.

### DETAILED DESCRIPTION

The present invention is further described below in conjunction with the accompanying drawings and specific embodiments, but is not used as a limitation of the present invention.

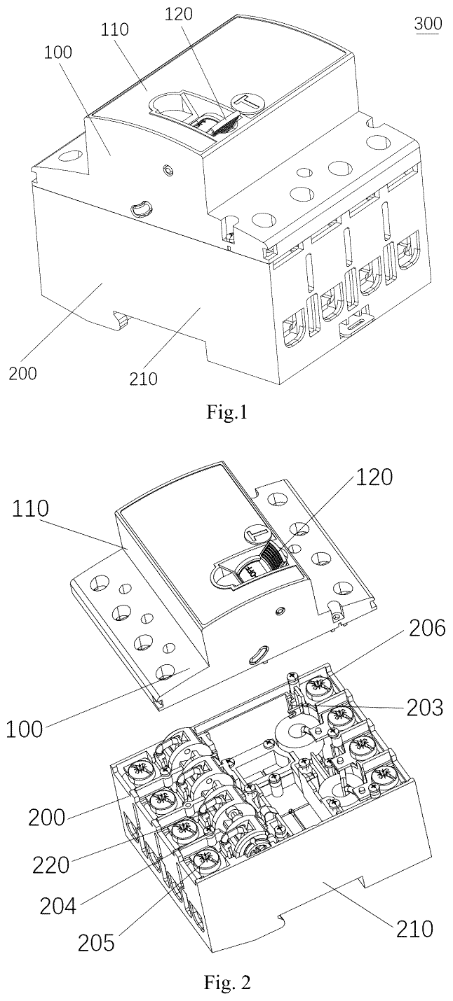

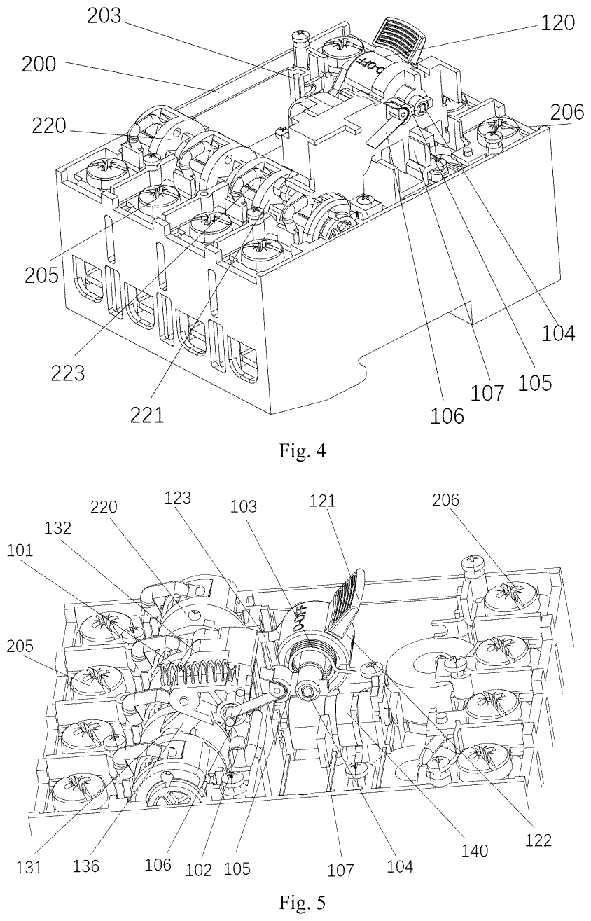

Referring to FIGS. 1-6, there is shown a circuit protection apparatus 300 comprising a compact switch module 100 and a base 200.

The compact switch module 100, comprises:
a first housing 110;
a handle assembly 120, installed in the first housing 110;
a tripping mechanism 130, installed in the first housing 110, the handle assembly 120 is connected to the tripping mechanism 130, and the tripping mechanism 130 has a first output end 131, the first output end 131 is movable in a first position or a second position;
an electromagnetic mechanism 140, installed in the first housing 110, the electromagnetic mechanism 140 has a movable second output end 141, and the second output end 141 is used for contacting the tripping mechanism 130.

The handle assembly 120 is used for controlling the tripping mechanism 130 to be in a locking state or a tripping state.

When the tripping mechanism 130 is in the locking state, not shown in the drawings, the first output end 131 is in the first position.

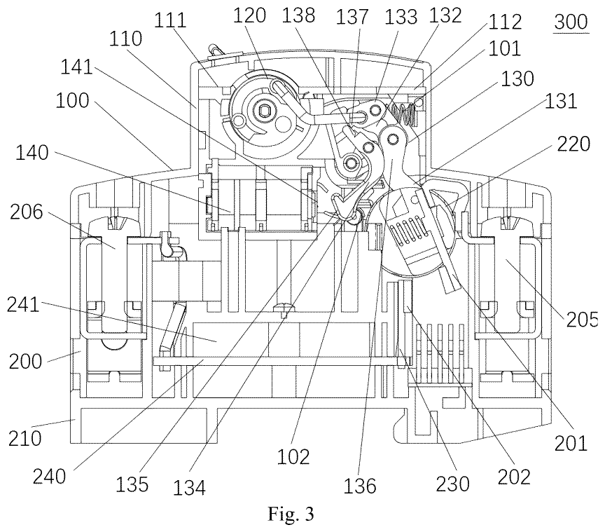

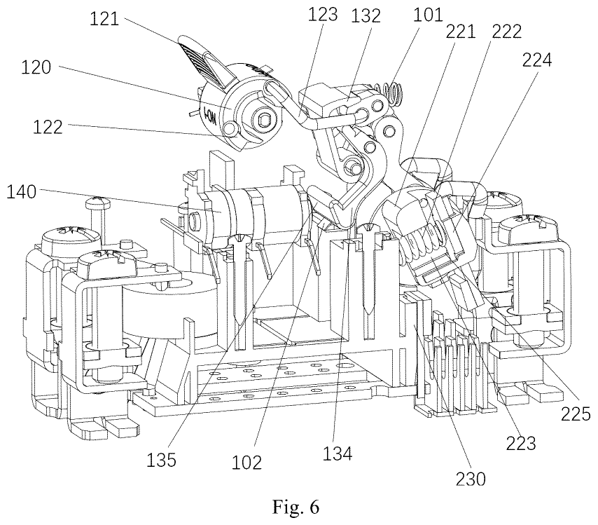

When the tripping mechanism 130 is in the tripping state, shown on FIGS. 3 and 6, the first output end 131 is in the second position which is different from the first position; the electromagnetic mechanism 140 is used for driving the tripping mechanism 130 to enter the tripping state from the locking state.

Further, the first output end 131 is used for controlling the operation of a gate mechanism for circuit on/off, the gate mechanism preferably comprises a moving contact 201 and a static contact 202, and the first output end 131 is used for controlling the movement of the moving contact 201 to realize the action of closing and opening the circuit.

Preferably, the handle assembly 120 is a manual driving end, that is, the user can directly manually operate the handle assembly 120 to control the tripping mechanism 130 to be in the corresponding state, so that the first output end 131 can be switchably in different positions to trigger or end the corresponding function, and preferably the current in the corresponding circuit is turned on or off. Preferably, the first position and the second position correspond to the position where the circuit can be turned on and the position where the circuit can be turned off, respectively.

At the same time, the electromagnetic mechanism 140 is used as an electromagnetic driving end to realize automatic operation. Preferably, a control module is also arranged, the control module is used for obtaining the corresponding indication signal, and the indication signal comes from the detection of any that can be detected, such as the circuit sensor has been used, and is judged to meet the situation that the circuit is disconnected, and the electromagnetic mechanism 140 is controlled to drive the tripping mechanism 130 to carry out the corresponding state change, and the first output end 131 is returned to the initial position, so as to prevent the occurrence of low-frequency short-circuit current.

Further, as a preferred embodiment, the control module is preferably a PCBA connected to a current sensor.

Further, as a preferred embodiment, a slot structure 203 for installing a control module is arranged on the second housing 210. Further, a part of the control module may be pre-installed in the second housing 210 or the first housing 110, and then another part of the control module may be covered when the first housing 110 or the second housing 210 is installed.

Further, as a preferred embodiment, the first housing 110 comprises a first portion 111 and a second portion 112 sequentially arranged along a horizontal direction.

The handle assembly 120 is arranged at the upper part in the first portion 111, and the electromagnetic mechanism 140 is arranged at the lower part in the first portion 111.

The tripping mechanism 130 is arranged in the second portion 112, and the first output end 131 is extended downward. As employed herein, the vertical direction refers to a direction of depth of a second housing 210 that contains the gate mechanism to be controlled. In other words, the first output end 131 is extended towards the bottom of the second housing 210 that contains the gate mechanism to be controlled. The top of the second housing 210 is intended to be covered by the first housing 110.

As employed herein, the horizontal direction refers to a direction perpendicular to the vertical direction.

Further, the tripping mechanism 130 preferably has a certain extension size along the vertical direction, so that the electromagnetic mechanism 140 can contact the lower part of the tripping mechanism 130 along the horizontal direction, and through this kind of arrangement, the handle assembly 120, the electromagnetic mechanism 140 and the tripping mechanism 130 are jointly arranged in a relatively compact manner, so as to facilitate subsequent installation and disassembly; in particular, this arrangement allows the user to move the compact switch module 100 in the vertical direction and install it on the corresponding base 200.

Further, as a preferred embodiment, the first housing 110 preferably comprises: an inner housing and an outer housing, the outer housing is sleeved on the outer side of the inner housing. At least part of the tripping mechanism 130, the electromagnetic mechanism 140, and the handle assembly 120 are accommodated in the inner housing, and the other part of the handle assembly 120 is allowed to be exposed to at least the outer side of the outer housing. Further, the user can drive the entire compact switch module 100 to move by directly moving the inner housing, and make it mount to a predetermined position, and then further limit it through the outer housing.

Further, as a preferred embodiment, an opening is formed on the first housing 110, the first output end 131 passes through the opening and extends outward. Further, the first output end 131 is preferably exposed to the lower edge of the first housing 110 in order to connect to the base 200.

Further, as a preferred embodiment, the first portion 111 and the second portion 112 are preferably formed at the left and right ends of the inner housing.

Further, as a preferred embodiment, the second output end 141 is moved along a horizontal direction.

Further, as a preferred embodiment, the handle assembly 120 comprises: an operating portion 121, a rotating portion 122 and a connecting rod 123;

The rotating portion 122 is movably installed in the first housing 110, one end of the operating portion 121 is connected to the rotating portion 122, and an other end of the operating portion 121 passes through the first housing 110 and extends outwardly;
one end of the connecting rod 123 is linked with the rotating portion 122, and an other end of the connecting rod 123 is connected to the tripping mechanism 130.

Further, the operating portion 121 is a hand contact part directly operated by the user, and the user can cause the rotating portion 122 to rotate in the first housing 110 by exerting force on the operating portion 121, thereby driving the movement of the connecting rod 123.

Further, as a preferred embodiment, the rotating portion 122 may be marked with an operation gear identification, such as ON, OFF, etc., and a window, which is large enough, is formed on the first housing 110 to at least partially expose the operation gear identification on the rotating portion 122.

Further, as a preferred embodiment, the middle part of the connecting rod 123 has an obtuse angle-like bending part which is obtuse angle and is upward.

Further, as a preferred embodiment, the tripping mechanism 130 comprises:
a rotating disc 132, rotatably arranged in the first housing 110;
a first connector 133, two ends of the first connector 133 are connected to the rotating disc 132 and the handle assembly 120 respectively;
a second connector 134, one end of the second connector 134 is connected to the rotating disc 132, an other end of the second connector 134 forms a contact end 135, and the contact end 135 is used for contacting the second output end 141;
a third connector 136, one end of the third connector 136 is connected to the rotating disc 132, and an other end of the third connector 136 forms the first output end 131.

The first connector 133 matches the second connector 134 so that the tripping mechanism 130 is in the locking state or the tripping state.

Preferably, when the first connector 133 and the second connector 134 are in contact and snapped, they are in said locking state, not shown in the drawings, and when the first connector 133 and the second connector 134 move relatively easily, they are in said tripping state show on FIG. 3.

Further, as a preferred embodiment, the cross-section of the rotating disc 132 along the vertical direction is preferably in a sector structure.

Further, as a preferred embodiment, the two ends of the connecting rod 123 are rotatably connected to the rotating portion 122 and the first connector 133 respectively, the first connector 133 is rotatably arranged on the rotating disc 132, the second connector 134 is rotatably arranged on the rotating disc 132, and one end of the third connector 136 is rotatably arranged on the rotating disc 132.

Further, as a preferred embodiment, when in the state as shown in FIG. 3, the first connector 133, the second connector 134 and the third connector 136 have respective hinge points with the rotating disc 132 that are respectively arranged sequentially from top to bottom.

Further, as a preferred embodiment, a protrusion 137 is formed on the first connector 133, and a depression 138 is formed on the second connector 134.

When in the locking state, the protrusion 137 extends into the inner of the depression 138.

When in the tripping state, the protrusion 137 detaches outwards from the inner of the depression 138, as shown in FIG. 3.

Further, as a preferred embodiment, the protrusion 137 protrudes outwards at the lower edge of one end of the first connector 133, in which the end of the first connector 133 is close to the connecting rod 123.

Further, as a preferred embodiment, the outer contour of the protrusion 137 is preferably in an acute angle structure.

Further, as a preferred embodiment, the depression 138 is formed in a concave at the upper edge of one end of the second connector 134, in which the end of the second connector 134 is close to the first connector 133.

Further, as a preferred embodiment, the width dimension of the lower part of the second connector 134 is greater than the width dimension of the upper part of the second connector 134, in other words, the outer contour of the second connector 134 at the lower part of the depression 138 is larger, and the outer contour of the second connector 134 at the upper part of the depression 138 is smaller, so that the protrusion 137 is easily guided outward from the upper part of the depression 138.

Further, as a preferred embodiment, the compact switch module 100 further comprising: a first elastic element 101, wherein the first elastic element 101 is arranged between the first housing 110 and the rotating disc 132.

Further, the first elastic element 101 is used for applying an elastic force to the rotating disc 132 so that it tends to approach the handle assembly 120 and to reset after tripping.

Further, as a preferred embodiment, the compact switch module 100 further comprising: a second elastic element 102, the second elastic element 102 is arranged below the tripping mechanism 130, and the second elastic element 102 is used for contacting the contact end 135 of the second connector 134. Further, the second elastic element 102 is used to provide an elastic force to the contact end 135, and the elastic force causes the depression 138 of the second connector 134 to keep close contact with the protrusion 137 of the first connector 133, in other words, the elastic force is used to make the depression 138 tend to be close to the protrusion 137, so as to ensure stability in the locking state.

Further, as a preferred embodiment, the second elastic element 102 is preferably a leaf spring with an arc-shaped bending in the upper part. Further, the upper end of the leaf spring rests against the side of the contact end 135, which is away from the electromagnetic mechanism 140.

Further, as a preferred embodiment, the second elastic element 102 is preferably directly fixed in the first housing 110 through a limiting structure, or a corresponding limiting structure is provided through the second housing 210 to locate the lower end of the second elastic element 102 and allows the upper end of the second elastic element 102 to extend upwards and be close to the contact end 135.

Further, as a preferred embodiment, the compact switch module further comprising: a third elastic element 103, the third elastic element 103 is arranged between the first housing 110 and the rotating portion 122. Further, the third elastic element 103 is used to provide the elastic force of reset of the handle assembly 120.

Further, as a preferred embodiment, the third elastic element 103 is preferably a torsion spring sleeved on a transmission shaft 104, and the rotating portion 122 is preferably rotatably mounted on the first housing 110 through the transmission shaft 104. Preferably, the transmission shaft 104 is also used for the rotational connection of the fourth connector 105.

Further, as a preferred embodiment, the compact switch module 100 further comprising: a fourth connector 105, a first moving contact 106 and a first static contact 107, the fourth connector 105 is connected to the handle assembly 120, the first moving contact 106 is arranged on the fourth connector 105, the first static contact 107 is arranged below the fourth connector 105, and the first moving contact 106 movably contacts the first static contact 107. Further, through the fourth connector 105, the first moving contact 106 and the first static contact 107, an additional switch mechanism is jointly formed, and the additional switch mechanism is used for turning on or turning off the power supply circuit of the electromagnetic mechanism 140. Preferably, this can make the electromagnetic mechanism 140 drive the tripping mechanism 130 to disconnect the circuit, and the power supply circuit of the electromagnetic mechanism 140 is also disconnected accordingly simultaneously, so that the electromagnetic mechanism 140 is protected from damage.

The foregoing is only a preferred embodiment of the present invention and does not limit the embodiment and scope of protection of the present invention.

Based on above, the invention also has embodiments as follows:

Referring to FIGS. 1-6, there is shown a preferred embodiment, a circuit protection apparatus 300 comprising a compact switch module 100 as mentioned above, the first output end 131 is used for driving at least one second moving contact 201 to contact or separate from at least one second static contact 202, and the second moving contact 201 and the second static contact 202 are used for forming a main electrical connection.

Further, a plurality of groups of second moving contacts 201 and the second static contacts 202, which have one-to-one correspondence, can be arranged simultaneously on the circuit protection apparatus 300, the second moving contacts 201 and the second static contacts 202 of each group correspond to the main electrical connection of a circuit, and correspondingly only need to install an above-mentioned compact switch module 100 to realize the protection of a plurality of circuits.

In a further embodiment of the invention, the circuit protection apparatus 300 further comprising: a second housing 210, the first housing 110 is detachably mounted on the second housing 210;
a moving contact assembly 220, installed in the second housing 210, the first output end 131 is connected to the moving contact assembly 220, and the moving contact assembly 220 has at least one second moving contact 201;
a static contact assembly 230, installed in the second housing 210, and the static contact assembly 230 has at least one second static contact 202, and the moving contact assembly 220 and the static contact assembly 230 are used for forming the main electrical connection

Further, through the second housing 210, the moving contact assembly 220 and the static contact assembly 230, the base 200 for the compact switch module 100 is formed together. Preferably, through the installation of the compact switch module 100, the first output end 131 can be connected to the moving contact assembly 220, and then the closing and opening action of the moving contact assembly 220 is controlled, so that the circuit is connected and disconnected.

In a further embodiment of the invention, the moving contact assembly 220 comprises: a rotating support 221 and at least one fourth elastic element 222;
the rotating support 221 is rotatably arranged in the second housing 210, and the rotating support 221 is connected to the first output end 131;
the rotating support 221 is provided with a guide channel 223, one end of the second moving contact 201 is movably installed in the guide channel 223, and the fourth elastic element 222 is arranged between one end of the second moving contact 201 and the inner wall of the guide channel 223;
an other end of the second moving contact 201 extends to the outer side of the rotating support 221 and is used for contacting the second static contact 202.

Further, the second moving contact 201 is movably arranged in the rotating support 221, and when the rotating support 221 is rotated by the force of the first output end 131, the second moving contact 201 is close to the second static contact 202 under the constraints of the guide channel 223 and the elastic action of the fourth elastic element 222, and remains stably close to it.

In a further embodiment of the invention, the guide channel 223 has at least a penetration part along the radial direction of the rotating support 221 so that the second moving contact 201 can pass there through, and the internal extension direction of the guide channel 223 is a diameter direction perpendicular to the penetration direction of the penetration part.

In a further embodiment of the invention, the radial section of the rotating support 221 is arranged in a circular manner, and the first output end 131 is hinged with the periphery of the radial section.

In a further embodiment of the invention, a plurality of rotating supports 221 can be arranged to carry a plurality of second moving contacts 201, or it can be achieved by a plurality of guide channels 223 being formed on a rotating support 221.

In a further embodiment of the invention, the first housing 110 and the second housing 210 are at least allowed to be detachably connected more easily.

In a further embodiment of the invention, the detachable connection of the rotating support 221 and the first output end 131 can be realized by the following method: a pin, which is parallel to the rotating shaft of the rotating support 221, passes through the peripheral of the rotating support 221 and the end of the first output end 131.

In a further embodiment of the invention, the fourth elastic element 222 is a spring that is used to provide at least an elastic force so that the second moving contact 201 tends to approach the second static contact 202, so that the second moving contact 201 and the second static contact 202 can maintain good contact.

In a further embodiment of the invention, a limiting block 224 is formed on the second moving contact 201, a limiting groove 225 is formed in the guide channel 223, and the limiting block 224 is slidably arranged in the limiting groove 225. Preferably, the slide includes, but is not limited to, translating and turning.

In a further embodiment of the invention, the circuit protection apparatus 300 further comprising: a fuse 240, the fuse 240 is used to disconnect the main electrical connection. Further, the main electrical connection is disconnected by the fusing of the fuse 240 in a predetermined condition, so that the protective effect is realized, and the disconnection occurs while the second moving contact 201 and the second static contact 202 are still in contact.

In a further embodiment of the invention, the fuse 240 is at least electrically connected to the moving contact assembly 220 or the static contact assembly 230. Further, the electrical connection may be implemented by direct contact with the moving contact assembly 220 or the static contact assembly 230 or by indirect contact through a wire, so as to participate in the main electrical connection described above.

In a further embodiment of the invention, one end of the fuse 240 is electrically connected to the static contact assembly 230, and the protection can be provided in the current range of several hundred amperes to one hundred thousand amperes through the setting of the fuse 240.

In a further embodiment of the invention, the lower part of the second housing 210 forms an enclosed space 241, the fuse 240 is arranged in the enclosed space 241, and the enclosed space 241 is filled with filler.

In a further embodiment of the invention, the filler is preferably sand.

In a further embodiment of the invention, the first housing 110 is fixed to the second housing 210 through a plurality of screws 204.

In a further embodiment of the invention, the two sides of the first housing 110 have extension parts that cover the upper part of the second housing 210 by extending outward in a horizontal direction.

In a further embodiment of the invention, each of the extension parts is provided with a screw hole for the installation of the screw 204.

In a further embodiment of the invention, the circuit protection apparatus 300 further comprising: at least one first terminal 205 and at least one second terminal 206 for connecting to an external circuit, the first terminal 205 and the second terminal 206 are all arranged in the second housing 210, the first terminal 205 is electrically connected with the second moving contact 201, and the second terminal 206 is electrically connected to the other end of the fuse 240.

In a further embodiment of the invention, the electrical connection between the terminal and other structures is preferably through wires, etc.

In a further embodiment of the invention, the outer wall of the second housing 210 is provided with an interface for connecting the external line to the corresponding terminal.

The above is only a preferred embodiment of the present invention, and does not limit the embodiment and scope of protection of the present invention, and those skilled in the art should realize that all schemes obtained by using the equivalent substitution and obvious changes made by the description and drawings of the present invention should be included in the scope of protection of the present invention.

What is claimed is:

1. A circuit protection apparatus (300), comprising:
a first housing (110);
a handle assembly (120), installed in the first housing (110);
a tripping mechanism (130), installed in the first housing (110), the handle assembly (120) is connected to the tripping mechanism (130), and the tripping mechanism (130) has a first output end (131), the first output end (131) is movable in a first position or a second position;
an electromagnetic mechanism (140), installed in the first housing (110), the electromagnetic mechanism (140) has a movable second output end (141), and the second output end (141) is used for contacting the tripping mechanism (130);
wherein the handle assembly (120) is used for controlling the tripping mechanism (130) to be in a locking state or a tripping state;
when the tripping mechanism (130) is in the locking state, the first output end (131) is in the first position;
when the tripping mechanism (130) is in the tripping state, the first output end (131) is in the second position which is different from the first position;
the electromagnetic mechanism (140) is used for driving the tripping mechanism (130) to enter the tripping state from the locking state;
the circuit protection apparatus (300) further comprising:
a second housing (210), the first housing (110) is detachably mounted on the second housing (210);
a moving contact assembly (220), installed in the second housing (210), the first output end (131) is connected to the moving contact assembly (220);
a static contact assembly (230), installed in the second housing (210), wherein the moving contact assembly (220) and the static contact assembly (230) are configured for forming a main electrical connection when the first output end (131) is in the first position and for breaking the main electrical connection when the first output end (131) is in the second position.

2. The circuit protection apparatus (300) of claim 1, wherein the first housing (110) comprises a first portion (111) and a second portion (112) sequentially arranged along a horizontal direction;
the handle assembly (120) is arranged at the upper part in the first portion (111), and the electromagnetic mechanism (140) is arranged at the lower part in the first portion (111);
the tripping mechanism (130) is arranged in the second portion (112).

3. The circuit protection apparatus (300) of claim 1, wherein an opening is formed on the first housing (110), the first output end (131) passes through the opening and extends outward of the first housing (110).

4. The circuit protection apparatus (300) of claim 1, wherein the handle assembly (120) comprises: an operating portion (121), a rotating portion (122) and a connecting rod (123);
the rotating portion (122) is movably installed in the first housing (110), one end of the operating portion (121) is connected to the rotating portion (122), and an other end of the operating portion (121) passes through the first housing (110) and extends outwardly;
one end of the connecting rod (123) is linked with the rotating portion (122), and an other end of the connecting rod (123) is connected to the tripping mechanism (130).

5. The circuit protection apparatus (300) of claim 1, wherein the tripping mechanism (130) comprises:
a rotating disc (132), rotatably arranged in the first housing (110);
a first connector (133), two ends of the first connector (133) are connected to the rotating disc (132) and the handle assembly (120) respectively;
a second connector (134), one end of the second connector (134) is connected to the rotating disc (132), an other end of the second connector (134) forms a contact end (135), and the contact end (135) is used for contacting the second output end (141);
a third connector (136), one end of the third connector (136) is connected to the rotating disc (132), and an other end of the third connector (136) forms the first output end (131);
wherein, the first connector (133) matches the second connector (134) so that the tripping mechanism (130) is in the locking state or the tripping state.

6. The circuit protection apparatus (300) of claim 5, wherein a protrusion (137) is formed on the first connector (133), and a depression (138) is formed on the second connector (134);
when in the locking state, the protrusion (137) extends into the inner of the depression (138);
when in the tripping state, the protrusion (137) detaches outwards from the inner of the depression (138).

7. The circuit protection apparatus of (300) claim 5, further comprising: a first elastic element (101), wherein the first elastic element (101) is arranged between the first housing (110) and the rotating disc (132).

8. The circuit protection apparatus (300) of claim 5, further comprising: a second elastic element (102), the second elastic element (102) is arranged below the tripping mechanism (130), and the second elastic element (102) is used for contacting the contact end (135) of the second connector (134).

9. The circuit protection apparatus (300) of claim 4, further comprising: a third elastic element (103), the third elastic element (103) is arranged between the first housing (110) and the rotating portion (122).

10. The circuit protection apparatus (300) of claim 1, further comprising: a fourth connector (104), a first moving contact (106) and a first static contact (107), the fourth connector (104) is connected to the handle assembly (120), the first moving contact (106) is arranged on the fourth connector (104), the first static contact (107) is arranged below the fourth connector (104), and the first moving contact (106) movably contacts the first static contact (107).

11. The circuit protection apparatus (300) of claim 1, wherein the moving contact assembly (220) has at least one second moving contact (201), the static contact assembly (230) has at least one second static contact (202), the first output end (131) is used for driving the at least one second moving contact (201) to contact or separate from the at least one second static contact (202).

12. The circuit protection apparatus (300) of claim 11, wherein the moving contact assembly (220) comprises:
a rotating support (221) and at least one fourth elastic element (222);
the rotating support (221) is rotatably arranged in the second housing (210), and the rotating support (221) is connected to the first output end (131);
the rotating support (221) is provided with a guide channel (223), one end of the second moving contact (201) is movably installed in the guide channel (223), and the fourth elastic element (222) is arranged between one end of the second moving contact (201) and the inner wall of the guide channel (223);
an other end of the second moving contact (201) extends to the outer side of the rotating support (221) and is used for contacting the second static contact (202).

13. The circuit protection apparatus (300) of claim 12, wherein a limiting block (224) is formed on the second moving contact (201), a limiting groove (225) is formed in the guide channel (223), and the limiting block (224) is slidably arranged in the limiting groove (225).

14. The circuit protection apparatus (300) of claim 11, further comprising: a fuse (240), the fuse (240) is configured to disconnect the main electrical connection.

15. The circuit protection apparatus (300) of claim 14, wherein the fuse (240) is at least electrically connected to the moving contact assembly (220) or the static contact assembly (230).

16. The circuit protection apparatus (300) of claim 14, wherein the lower part of the second housing (210) forms an enclosed space (241), the fuse (240) is arranged in the enclosed space (241), and the enclosed space (241) is filled with filler.
